(19) United States
(12) Patent Application Publication
(10) Pub. No.: US 2025/0306967 A1
(43) Pub. Date: Oct. 2, 2025

(54) HOST DOMAIN COMPOSITOR FOR MANAGING RENDERED DISPLAY STREAMS IN A VIRTUALIZED ENVIRONMENT

(71) Applicants: ATI TECHNOLOGIES ULC, Markham (CA); ADVANCED MICRO DEVICES, INC., Santa Clara, CA (US)

(72) Inventors: Hui Yu, Richmond Hill (CA); Kun Xue, Shanghai (CN); Lili Gong, Shanghai (CN)

(21) Appl. No.: 18/616,785

(22) Filed: Mar. 26, 2024

(51) Int. Cl. G06F 9/455

(52) U.S. Cl. CPC G06F 9/45558; G06F 2009/4557

(57) ABSTRACT

A computing system includes memory and at least one processor. A virtualization environment executable by the at least one processor. A host virtual machine and a plurality of guest virtual machines are implemented within the virtualization environment. A compositor is implemented within the host virtual machine. The compositor is to receive a first set of display data from a first guest virtual machine of the plurality of virtual machines and a second set of display data from a second guest virtual machine of the plurality of virtual machines. The compositor is further to output the first set of display data to a first physical display and the second set of display data to a second physical display.

### BACKGROUND

In virtualization environments, multiple virtual machines (VMs) operate on a single physical hardware platform. Each VM functions as an independent unit, capable of running its own operating system and applications. This technology not only optimizes hardware utilization but also enhances flexibility and scalability in deploying various computing resources. In a typical virtualized environment, VMs are managed by a hypervisor or virtual machine monitor (VMM), which allocates hardware resources such as processing hardware, memory, and storage. However, the presentation of graphics and image data from these VMs on physical displays poses unique challenges. Traditionally, VMs have relied on software-based rendering techniques to process graphics, which are then transmitted to physical displays.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of an example computing system in accordance with some implementations.

FIG. 2 is a block diagram of portions of the computing system of FIG. 1 implementing a virtualized computing environment in accordance with implementations.

FIG. 3 is a block diagram illustrating various components implemented by the a host domain compositor of the virtualized computing environment of FIG. 2 in accordance with at least some implementations.

FIG. 4 is a diagram illustrating an example of the host domain compositor of FIG. 3 managing display data generated by multiple guest virtual machines in accordance with at least some implementations.

FIG. 5 is a diagram illustrating an example of the host domain compositor of FIG. 3 switching a physical display between different guest virtual machines managing display data generated by multiple guest virtual machines in accordance with at least some implementations.

FIG. 6 is a flow diagram illustrating an example method of a host domain compositor managing display data generated by multiple guest virtual machines in accordance with at least some implementations.

### DETAILED DESCRIPTION

The graphical presentation of data from VMs to physical displays is an important aspect of virtualization technology. Traditionally, this process involves software-based rendering within each VM, followed by transmission of the rendered graphics to the displays. While this approach is functional, it introduces significant processing overhead and latency, leading to suboptimal performance. The use of separate compositors for each VM has been explored as a potential solution to these challenges. A compositor is typically a software component that combines visual elements from various applications into a single image for display. When each VM has its own dedicated compositor, the VM can manage its graphical output more efficiently. This setup allows for better control over the rendering process and can potentially reduce the latency and overhead associated with graphics rendering in a virtualized environment.

However, while separate compositors offer improvements in managing individual VM outputs, they also introduce new complexities. One significant challenge is the coordination and synchronization between these compositors, especially when multiple VMs are displaying their output to different physical displays simultaneously. This issue becomes more pronounced in scenarios requiring high-resolution graphics or real-time rendering, where any delay or asynchrony can significantly impact the quality of the display output. Also, the implementation of separate compositors in a virtualized environment necessitates sophisticated resource allocation strategies. For example, the hypervisor or VMM needs to effectively distribute the available computational and graphical resources among the various VMs and their compositors. Given that that the resource demands of each VM and compositor can vary or be unpredictable, the hypervisor or VMM typically needs to continuously monitor and adapt to these changing demands to prevent resource contention, which can lead to performance degradation. Also, failure to effectively manage the resources for multiple compositors results in inefficiencies, such as underutilized hardware or bottlenecks, which undermine the benefits of virtualization.

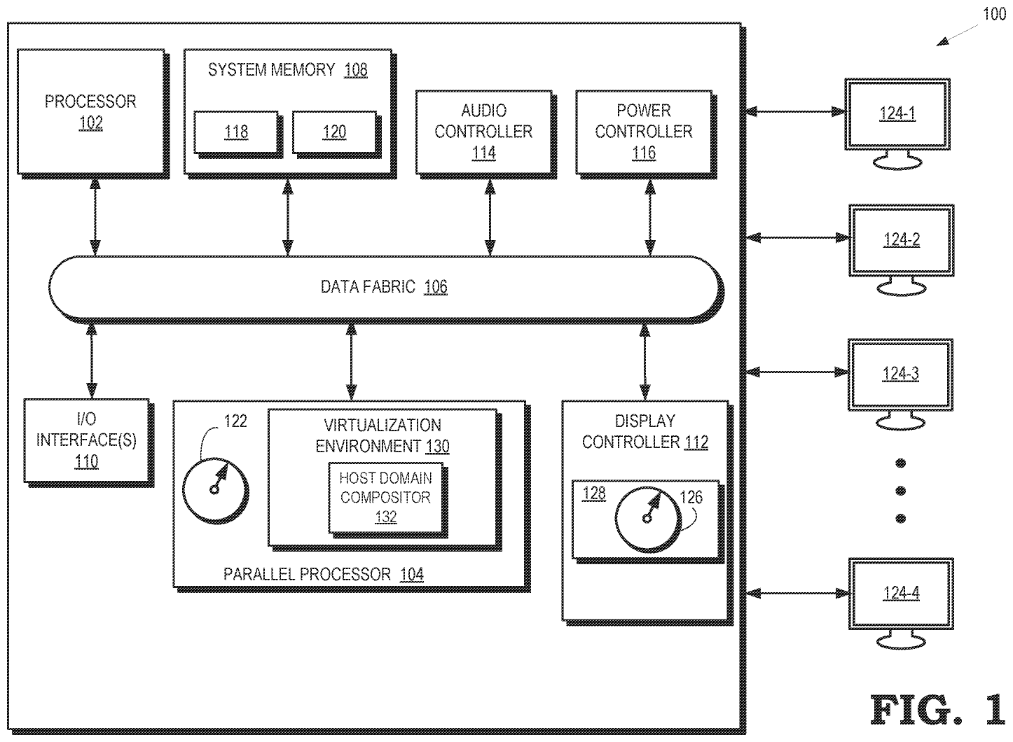

To address these and other problems, FIG. 1 to FIG. 6 describe systems and methods that implement a host domain compositor for managing rendered display streams in a virtualized environment. As described in greater detail below, a host VM (host domain) in a virtualization environment supports multiple physical displays that are served by guest VMs. The host VM operates as a compositing interface between a VMM and the guest VMs such that the host VM manages display streams for multiple physical displays. The host VM employs a host domain compositor that operates to provide routing and switching between the guest VMs and the physical displays. In at least some implementations, the host domain compositor performs pre-display processing of display streams generated by the guest VMs. For example, the host domain compositor receives display streams rendered by each of the guest VMs, and formats the display streams to be compatible with the corresponding physical display, applies one or more display features (e.g., high-bandwidth digital content protection (HDCP), FreeSync, or the like), a combination thereof, or the like. The host domain compositor directs the resulting display streams to the corresponding physical displays via system display drivers and display controllers. In at least some implementations, the host domain compositor ensures that any graphical user interfaces (GUIs) or overlays associated with the host OS do not appear in the output display streams to the physical displays such that it appears that each physical display is being controlled through a separate processor.

Implementing a single compositor at the host VM, as opposed to separate compositors for each guest VM, presents several advantages. Centralizing the compositing process simplifies resource management significantly, as there is only one compositor managing the graphical output for all VMs. This unified approach reduces the complexity involved in resource allocation and synchronization, leading to more efficient use of hardware resources, such as computing and graphics processing resources. The host domain compositor described herein also eliminates the need for intricate balancing of resources among multiple compositors, thereby reducing overhead and potential bottlenecks. Moreover, the host domain compositor more effectively manages the rendering pipeline and allocate graphical resources based on the overall demand, which can enhance the system's performance, especially in scenarios with varying graphical loads. This centralized management also aids in maintaining coherence and consistency in the graphical output across different VMs, as all rendering tasks are processed through a common pipeline. Additionally, security and isolation concerns are more straightforward to address with a single compositor, since there is a reduced risk of cross-VM interference or resource contention. As such, the host domain compositor described herein streamlines the operation of a virtualized environment, leading to improved performance, easier maintenance, and potentially lower operational costs.

FIG. 1 illustrates a block diagram of a computing system 100 employing a host domain compositor within a virtualization environment that operates to manage display streams generated by multiple virtual machines in accordance with at least some implementations. The computing system 100, in at least some implementations, includes at least one or more processing devices, such as a processor 102 and a parallel processor 104, a fabric 106, memory 108, an input/output (I/O) interface(s) 110, a display controller 112, an audio processing device 114, a power controller 116, and the like, The computing system 100, in at least some implementations, is a computer, laptop, mobile device, server, vehicle human-machine interface, or any of various other types of computing systems or devices. It is noted that the number of components of the computing system 100 may vary. It is also noted that in implementations, computing system 100 includes other components not shown in FIG. 1, and the computing system 100, in at least some implementations, is structured differently than shown in FIG. 1.

The fabric 106 is representative of any communication interconnect that complies with any of various types of protocols utilized for communicating among the components of the computing system 100. The fabric 106 provides the data paths, switches, routers, and other logic that connect the processor 102, parallel processor 104, memory 108, input/output (I/O) interface(s) 110, display controller 112, audio processing device 114, power controller 116, and other devices to each other. The fabric 106 handles the request, response, and data traffic, as well as probe traffic to facilitate coherency. Interrupt request routing and configuration of access paths to the various components of the computing system 100 are also handled by the fabric 106. Additionally, the fabric 106 handles configuration requests, responses, and configuration data traffic. In at least some implementations, the fabric 106 is bus-based, including shared bus configurations, crossbar configurations, and hierarchical buses with bridges. In other implementations, the fabric 106 is packet-based and hierarchical with bridges, crossbar, point-to-point, or other interconnects. From the point of view of the fabric 106, the other components of computing system 100 are referred to as “clients”. The fabric 106 is configured to process requests generated by various clients and pass the requests on to other clients.

The memory 108 includes system memory or another storage component that is implemented using a non-transitory computer readable medium, such as dynamic random-access memory (DRAM), Static Random Access Memory (SRAM), NAND Flash memory, NOR (Not Or) flash memory, Ferroelectric Random Access Memory (FeRAM), or others. The I/O interface(s) 110 is representative of any number and type of I/O interfaces (e.g., peripheral component interconnect (PCI) bus, PCI-Extended (PCI-X), PCIE (PCI Express) bus, gigabit Ethernet (GBE) bus, universal serial bus (USB)). Various types of peripheral devices are coupled to the I/O interface(s) 110. Such peripheral devices include (but are not limited to) displays, keyboards, mice, printers, scanners, joysticks or other types of game controllers, media recording devices, external storage devices, network interface cards, and so forth.

The audio processing device 114, such as an audio controller, generates audio signals that can be output by the audio processing device 114 or another component of the computing system 100. The power controller 116, such as a system management unit (SMU) or another type of power controller, includes hardware and firmware for managing and accessing system configuration/status registers and memories, generating clock signals, controlling power rail voltages, and the like for the computing system 100. The power controller 116 also controls the power supplied to components and sub-components of the computing system 100, such as the cores of the processor 102, parallel processor 104, the I/O interface 110, the display controller 112, and the like.

The processor 102, in at least some implementations, is a processor such as a central processing unit (CPU) and supports the execution of instructions for graphics and other types of workloads. For example, the processor 102 executes instructions, such as program code 118, stored in the memory 108 and stores information in the memory 108, such as the results of the executed instructions. In another example, the processor 102 prepares and distributes one or more operations to the parallel processor 104 (or other computing resources) and then retrieves the results of one or more operations from the parallel processor 104. The processor 102 is also able to initiate graphics processing by issuing draw calls. In at least some implementations, the processor 102 includes multiple processing elements (not shown in FIG. 1 in the interest of clarity) that execute instructions concurrently or in parallel. The processing elements are referred to as processor cores, compute units, or using other terms.

The parallel processor 104, in at least some implementations, is a processor such as a vector processor, a graphics processing unit (GPU), a general-purpose GPU (GPGPU), a non-scalar processor, a highly-parallel processor, an artificial intelligence (AI) processor, an inference engine, a machine learning processor, another multithreaded processing unit, a digital signal processor (DSP), a field programmable gate array (FPGA), an application specific integrated circuit (ASIC), or the like. The parallel processor 104, in at least some implementations, is constructed as a multi-chip module (e.g., a semiconductor die package) including two or more base integrated circuit (IC) dies communicably coupled together with bridge chip(s) or other coupling circuits or connectors such that a parallel processor is usable (e.g., addressable) like a single semiconductor integrated circuit. As used herein, the terms “die” and “chip” are interchangeably used. Those skilled in the art will recognize that a conventional (e.g., not multi-chip) semiconductor integrated circuit is manufactured as a wafer or as a die (e.g., single-chip IC) formed in a wafer and later separated from the wafer (e.g., when the wafer is diced); multiple ICs are often manufactured in a wafer simultaneously. The ICs and possibly discrete circuits and possibly other components (such as non-semiconductor packaging substrates including printed circuit boards, interposers, and possibly others) are assembled in a multi-die parallel processor.

In at least some implementations, the parallel processor 104 is an accelerated processor (AP) that combines, for example, a general-purpose CPU and a GPU. The AP accepts both compute commands and graphics rendering commands from the processor 102 or another processor. The AP includes any cooperating collection of hardware, software, or a combination thereof that performs functions and computations associated with accelerating graphics processing tasks, data-parallel tasks, nested data-parallel tasks in an accelerated manner with respect to resources such as conventional CPUs, conventional GPUs, and combinations thereof. The AP and the processor 102, in at least some implementations, are formed and combined on a single silicon die or package to provide a unified programming and execution environment. In other implementations, the AP and the processor 102 are formed separately and mounted on the same or different substrates.

The parallel processor 104 includes one or more processing elements, such as an array of compute units (not shown in FIG. 1 in the interest of clarity) that execute instructions concurrently or in parallel. Some implementations of the parallel processor 104 are used for general-purpose computing. The parallel processor 104 executes instructions stored in the memory 108 and stores information in the memory 108, such as the results of the executed instructions. For example, the memory 108 stores a copy 120 of instructions that represent a program code that is to be executed by the parallel processor 104. The parallel processor 104 also includes a timing reference/generator 122.

The parallel processor 104, among other things, renders images and generates a stream of frames for presentation by one or more physical display devices 124 (illustrated as physical display 124-1 to physical display 124-4), which may include, for example, a screen, a monitor, a television, etc. For example, the parallel processor 104 renders objects to produce values of pixels that are provided by the display controller 112 to the one or more physical displays 124, which use the pixel values to display an image that represents the rendered objects. In implementations where multiple physical displays 124 are coupled to the computing system 100, the parallel processor 104 generates the same image(s) to be presented on each physical display 124 or generates a different image(s) to be presented on two or more of the physical displays 124.

The display controller 112 reads out the pixel values in the frames from an output buffer/memory and uses the values to generate one or more signals for displaying an image on (or presenting an image to) the physical display 124. The display controller 112 provides the video signal representing the frames via a physical interface, such as a high-definition multimedia interface (HDMI) or DisplayPort interface, coupled to the physical displays 124. The display controller 112 includes one or more timing references/generators 126 that generate control signals, synchronization signals, clock signals (independently or in conjunction with other circuitry or devices), a combination thereof, or the like that are required for interfacing to the physical display 124. In at least some implementations, the one or more timing references 126 are synchronized to, for example, the parallel processor timing reference 122 (or another timing reference) during normal operation. Some implementations of the timing reference 126 are implemented in a timing controller (TCON) chip 128, e.g., as an ASIC or other circuit, which also performs timing and synchronization operations for the physical display 124. Although the display controller 112 is illustrated in FIG. 1 as being separate from other components of the computing system 100, the display controller 112, in other examples, is part of another component(s), such as the parallel processor 104, the I/O interface 110, or the like.

The computing system 100, in at least some implementations, further includes one or more virtualization environments 130 employing a host domain compositor circuit 132 (also referred to herein as a “host domain compositor 132”) for managing display streams generated by multiple virtual machines of the virtualization environment 130. The host domain compositor 132, in at least some implementations, is implemented using one or more of hardware components, circuitry, firmware or a firmware-controlled microcontroller, or a combination thereof.

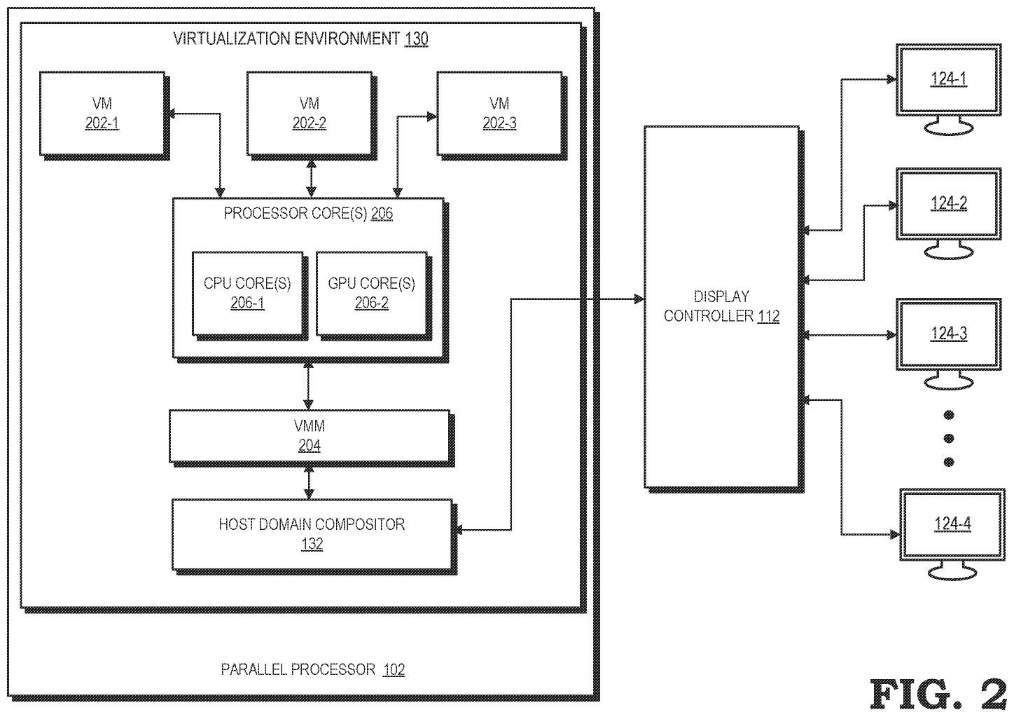

FIG. 2 shows an example of the parallel processor 104 implementing the virtualization environment 130. In this example, the virtualization environment 130 is instantiated with multiple virtual machines (VMs) 202 (illustrated as VM(1) 202-1 to VM(N) 202-3). The VMs 202 (also referred to herein as “domains 202”), in at least some implementations are configured in the system memory 108 of the computing system 100. Resources from physical devices of the parallel processor 104 and the computing system 100 are shared with the VMs 202. The resources include, for example, a graphics processor resource from the parallel processor 104, a central processing unit resource from the processor 102 or the parallel processor 104, a memory resource from memory 108, a network interface resource from a network interface controller, or the like. The VMs 202 use the resources for performing operations on various data (e.g., video data, image data, textual data, audio data, display data, peripheral device data, etc.). In at least some implementations, the computing system 100 includes a plurality of resources, which are allocated and shared amongst the VMs 202.

The computing system 100 also includes a virtual machine manager (VMM) 204 (also known as a virtualization manager or a hypervisor) that manages instances of VMs 202. The VMM 204 controls interactions between the VMs 202 and the various physical hardware devices, such as the parallel processor 104. The VMM 204 includes software components for managing hardware resources and software components for virtualizing or emulating physical devices to provide virtual devices, such as virtual disks, virtual processors, virtual network interfaces, or a virtual parallel processor for each VM 202. In at least some implementations, each VM 202 is an abstraction of a physical computer system and may include an operating system (OS) and applications, which are referred to as the guest OS and guest applications, respectively, wherein the term “guest” indicates it is a software entity that resides within the VMs 202.

The VMs 202 generally are instanced, meaning that a separate instance is created for each of the VMs 202. It should be understood that a host system may support any number N of virtual machines. As illustrated, the VMM 204 provides N virtual machines 202, with each of the virtual machines 202 providing a virtual environment wherein guest system software resides and operates. The guest system software includes applications (not shown) and VM kernel mode drivers (KMDs) (not shown), typically under the control of a guest OS. The VM KMDs control the operation of the parallel processor 104 by, for example, providing an API to software (e.g., applications) executing on the processor 102 to access various functions of the parallel processor 104. In some implementations, the computing system 100 comprises containers instead of, or in addition to, the VMs 202. In at least some of these implementations, the computing system 100 also comprises a container manager instead of, or in addition to, the VMM 204.

In at least some implementations one of the VMs 202, such as VM 202-1, is a host VM 202 (also referred to herein as a “host domain 202” or “privileged domain 202”) and each of the remaining VMs 202 is a guest VM 202 (also referred to herein as a “guest domain 202” or “unprivileged domain 202”). A host VM 202, in at least some implementations, manages the overall virtualization environment 130. The host VM 202-1 is distinct from regular, guest (unprivileged) VMs 202 due to its elevated level of access and control over the virtualization infrastructure. In at least some implementations, the host VM 202-1 is the first VM 202 initialized by the VMM 204 during the boot process. The host VM 202, in at least some implementations, runs a fully-featured operating system and is configured with special privileges that allow it to directly interact with the physical hardware of the host machine, such as the ability to manage memory, processing resources, and direct access to Input/Output (I/O) devices. This capability is not granted to the guest VMs 202 (e.g., VM 202-2 and VM 202-3).

One responsibility of the host VM 202-1 is to control the creation, execution, and termination of unprivileged VMs 202, effectively acting as the administrative authority in the virtualized environment 130. The host VM 202-1, in at least some implementations is also responsible for allocating hardware resources among the guest VMs 202 (e.g., VM 202-2 and VM 202-3), ensuring that each guest VM 202 has access to the necessary computing power, memory, and storage it requires to operate effectively. In at least some implementations, the host VM 202-1 also handles critical system-level functions, such as managing network configurations and storage operations. Other responsibilities of the host VM 202-1 include and managing the device drivers needed for the physical hardware, which includes handling the complexities of network interfaces, storage controllers, and other essential hardware components.

A guest VM 202 is configured to operate within the confines of a controlled and isolated environment provided by the host domain 202-1. The guest VMs 202 allow for multiple isolated virtual environments to coexist on a single physical hardware platform. A guest VM 202 is characterized by its limited privileges compared to the host VM 202-1. Unlike the host VM 202-1, which has direct access to the physical hardware and manages the VMM 204, a guest VM 202 operates in a more restricted environment. For example, a guest VM 202 does not have direct access to the hardware resources. Instead, a guest VM 202 interacts with virtualized hardware resources that are allocated and managed by the host VM 202-1. This configuration ensures a clear separation and isolation of tasks and operations between different VMs 202, enhancing security and stability. Also, each guest VM 202 functions as an independent unit with its own operating system, applications, and virtualized hardware resources, such as CPU, memory, and storage. These resources are assigned by the host VM 202-1, and the guest VMs 202 are typically unaware of the underlying physical resources or the presence of other VMs on the same host.

In the virtualized computing environment 200, when the parallel processor 104 is used to manage multiple physical displays 124, each VM 202 is allocated a portion of the parallel processor's 104 resources. This includes both processing power and graphics rendering capabilities provided by the processing core(s) 206 (e.g., CPU core(s) 206-1 and GPU core(s) 206-2). In at least some implementations, this allocation is managed through the use of the physical functions (PFs) and virtual functions (VFs). In at least some implementations, the GPU resources of the parallel processor 104 are virtualized using, for example, GPU-Passthrough. This allows multiple VMs 202 to share the GPU resources. Each VM 202 is allocated a VF, which acts as a virtual GPU. Within each VM 202, applications or processes that require graphics rendering use the allocated VF (virtual GPU). The VM's 202 operating system and drivers interact with this VF as if it were a physical GPU, rendering images accordingly.

Each VM 202, in at least some implementations, is connected to one or more of the physical displays 124. The GPU resource of the parallel processor 104 allocates separate resources for each display, ensuring that they can operate independently and display different content. Once the images are rendered within each VM 202, the images are sent to the assigned physical displays 124. This transmission is a coordinated effort involving the parallel processor's 104 hardware capabilities and virtualization software, which ensures that each physical display 124 receives the correct image output from the respective VM 202.

Conventionally, virtualization environments typically implement a separate component, such as a compositor, for each VM to manage the display output of the VM. However, as described above, implementing separate compositors for each VM creates coordination and synchronization between these compositors, necessitates sophisticated resource allocation strategies, and results in inefficiencies, such as underutilized hardware or bottlenecks. As such, in at least some implementations, the host VM 202-1 is instantiated with a single host domain compositor 132 that operates to provide routing and switching between the guest VMs 202 and the physical displays 124. Implementing a single compositor 132 within the host VM 202-1 instead of separate compositors at each guest VM 202 significantly simplifies resource management and streamlines the operation of the virtualized environment 130, leading to improved performance, easier maintenance, and potentially lower operational costs.

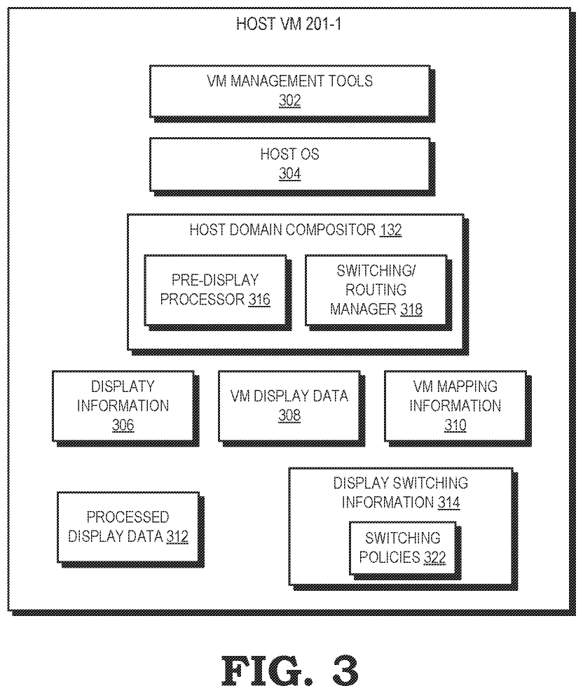

FIG. 3 shows an example of a more detailed view of the host domain 202-1 and the host domain compositor 132. It should be understood that other configurations of the host domain 202-1 and the host domain compositor 132 are applicable as well. In the example shown in FIG. 3, the host domain 202-1 includes VM management tools 302, a host OS 304, the host domain compositor 132, display information 306 (also referred to herein as “display properties 306”), VM display (image) data 308, VM mapping information 310, processed display data 312, and display switching information 314. In at least some implementations, one or more of the display information 306, VM display data 308, VM mapping information 310, processed display data 312, or display switching information 314 are maintained or stored in the memory 108, video random access memory (VRAM), buffers, registers, a combination thereof, or the like.

The host domain 202-1, in at least some implementations, utilizes the VM management tools 302 to create, monitor, and manage the guest VMs 202. The host OS 304 is the operating system running in the host domain 202-1. As described in greater detail below, the host domain compositor 132 manages VM display data 308, such as display streams, generated/rendered by the guest VMs 202. For example, the host domain compositor 132, in at least some implementations, includes a pre-display processing circuit 316 (also referred to as a “pre-display processor 316”) and a switching/routing management circuit 318 (also referred to herein as a “switching manager 318”). The pre-display processor 316 formats the VM display data 308 to be compatible with the corresponding physical display 124, applies one or more display features (e.g., high-bandwidth digital content protection (HDCP), FreeSync, or the like), a combination thereof, or the like. In at least some implementations, the pre-display processor 316 uses the display information 306 when pre-processing the VM display data 308. The display information 306, in at least some implementations, includes information indicating the capabilities or features of the physical display 124. Examples of the display information 306 include screen size, aspect ratio, resolution, pixel density, display technology, panel type, color depth, color gamut, brightness, contrast ratio, response time, High Dynamic Range (HDR) capability, backlighting information, adaptative synch technology capability, secure buffer information, the power state of the display, or the like. The pre-processing operations performed by the pre-display processor 316 on VM display data 308 generate processed display data 312, which is sent by the host domain compositor circuit 132 to the physical displays 124. However, in some instances, the VM display data 308 is not pre-processed by the pre-display processor 316. In these instances, the pre-display processor 316 outputs the VM display data 308 to the physical displays 124.

The switching manager 318 routes display data 308 generated by the guest VMS 202 to one or more of the physical display displays 124 and switches the physical displays 124 between the guest VMs 202. In at least some implementations, the switching manager 318 uses one or more of the VM mapping information 310 or the display switching information 314 to determine how to route the VM display data 308 to one or more of the physical displays 124 or switch the physical displays 124 between the guest VMs 202. The VM mapping information 310, in at least some implementations, is maintained in a data structure, such as a table, and indicates which of the physical displays 124, virtual displays, or a combination thereof a specified guest VM 202 is mapped or assigned to. The display switching information 314 includes, for example, switching policies 320. The switching policies/configurations 320 indicate one or more of a set of rules, conditions, or parameters governing how the switching manager 318 switches the physical displays 124 between the guest VMs 202. In one example, a switching policy 320 indicates that a first guest VM 202 is given priority over a second guest VM 202 for a specified physical display 124. In another example, a switching policy 320 indicates that a first data type is given priority over at least a second data type for a specified physical display(s).

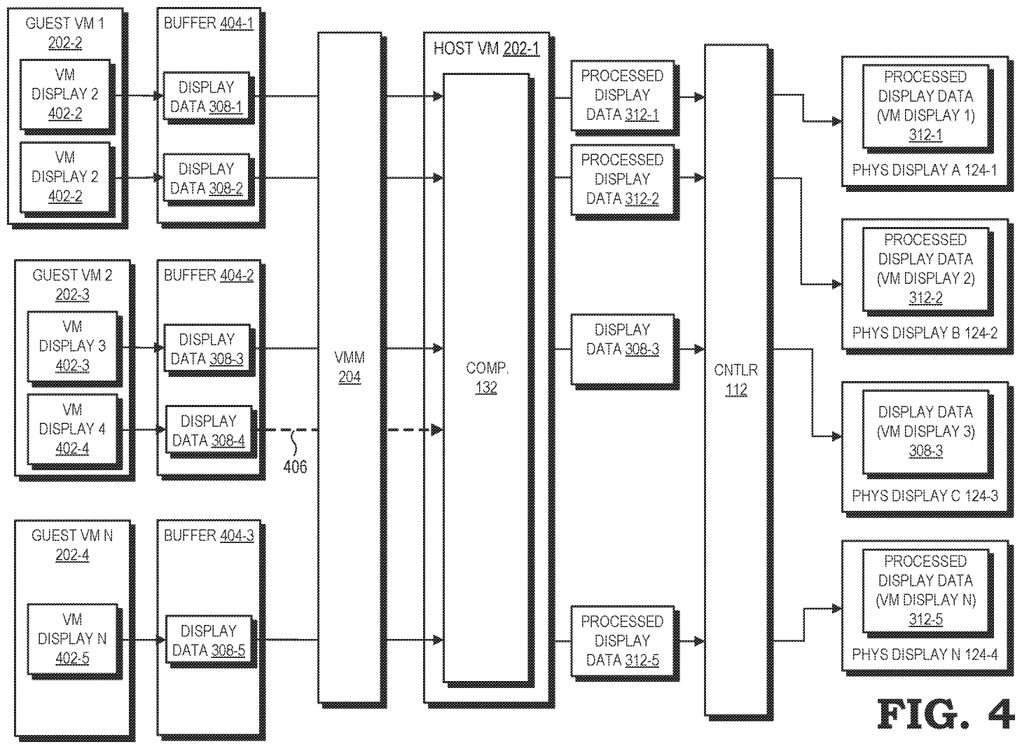

FIG. 4 shows one example of the host domain compositor 132 managing display data 308 generated by multiple guest VMs 202 of the virtualization environment 130. In this example, the VMM 204 allocates a virtual GPU to each guest VM 202 (illustrated as guest VM 202-2 to guest VM 202-4). Each guest VM 202 is also allocated or assigned to one or more of the physical displays 124. In this example, one or more of the guest VMs 202 are also configured with one or more virtual displays 402 (illustrates as virtual display 402-1 to virtual display 402-5). Applications and processes within each guest VM 202 render display data 308 using their allocated virtual GPU. In at least some implementations, a guest VM 202 renders display data 308 for at least one of its virtual displays 402 that is then output to a physical display 124 assigned to the guest VM 202.

The rendered display data, in at least some implementations is stored in a buffer 404 (illustrated as buffer 404-1 to buffer 404-3), such as a scan out buffer, or other storage mechanism. In at least some implementations, when a guest VM 202 renders a set of display data 308 or stores the display data 308 in the buffer 404, the VM 202 (or another component) signals the VMM 204 that the display data 308 has been generated. The VMM 204 then obtains the display data 308 from the buffer 404 and sends the display data 308 to the host domain compositor 132. For example, FIG. 3 shows that Guest_VM_1 202-2 has generated and stored display data 308-1 for virtual Display_1 402-1 and display data 308-2 for virtual Display_2 402-2, Guest_VM_2 202-3 has generated and stored display data 308-3 for virtual Display_3 402-3 and display data 308-4 for virtual Display_4 402-4, and Guest_VM_N 202-4 has generated and stored display data 308-5 for virtual Display_N 402-5. The VMM 204 obtains the display data 308 generated by the multiple VMs 202 and passes the display data 308 to the host domain compositor 132. In at least some implementations, the VMM 204 obtains display information 306 from one or more of the VMs 202 in addition to the display data 308 and passes the display information 306 to the host domain compositor 132.

The host domain compositor 132, in at least some implementations, maintains one or more buffers (not shown) or other storage mechanisms for storing the display data 308. Examples of the type of information includes in the display data 308 include bitmap images, pixel arrays, texture data, vertex data, layer information, metadata, a combination thereof, or the like. The host domain compositor 132, in at least some implementations, pre-processes the display data 308 received from one or more of the guest VMs 202 to generate processed display data 312 (illustrated as processed display data 312-1, 312-2, and 312-5) that is compatible with the corresponding physical display 124 or has one or more display features applied thereto.

For example, in at least some implementations, upon (or subsequent to) receiving display data 308, the pre-display processor 316 of the host domain compositor 132 determines the physical display(s) 124 assigned to the guest VM 202 based on the VM mapping information 310. In the example shown in FIG. 4, the pre-display processor 316 determines that Guest_VM_1 202-2 is assigned or mapped to physical Display_A 124-1 and physical Display_B 124-2, Guest_VM_2 202-3 is assigned or mapped to physical Display_C 124-3, and Guest_VM_N 202-4 is assigned to physical Display_N 124-4. The pre-display processor 316 accesses the display information 306 for one or more of the assigned physical displays 124 to determine of the corresponding display data 308 is to be processed before being output to the physical display 124. For example, display data 308-1 received from Guest_VM-1 may be in a first format or a first resolution but the display information 306 for physical Display_A 124-1 indicates that the display 124-1 is compatible with a second format or a second resolution. As such, the pre-display processor 316 transforms the display data 308-1 from the first format to the second format or resizes/rescales the display data 308-1 from the first resolution to the second resolution resulting in processed display data 312-1. In another example, the pre-display processor 316 applies one or more display features to the display data 308, such as HDCP or adaptive sync technology (e.g., FreeSync). However, if the pre-display processor 316 determines that display data 308 does not need to be processed, the display data 308 is left unprocessed, such as display data 308-3 in FIG. 3 received from Guest_VM_2. In at least some implementations, the pre-display processor 316 also pre-processes the display information 306 in addition to the display data 308.

After receiving or processing the display data 308, the host domain compositor 132 outputs the display data 308 (or processed display data 312) to the physical display 124 assigned to the guest VM 202 that generated the display data 308. In at least implementations, the switching manager 318 of the host domain compositor 132 selects one or more physical displays 124 for outputting the display data 308 received from a guest VM 202. For example, in at least some implementations, the switching manager 318 selects one or more physical displays 124 based on the VM mapping information 310. As described above, the VM mapping information 310 indicates which of the physical displays 124 are assigned to each of the guest VMs 202. In at least some implementations, if a guest VM 202 is configured with a virtual display 402, the VM mapping information 310 indicates the physical display 124 assigned to a virtual display 402 of a guest VM 202. In the example shown in FIG. 4, based on the VM mapping information 310, the switching manager 318 selects physical Display_A 124-1 and physical Display_B 124-2 for Guest_VM_1, selects physical Display_C 124-3 for Guest_VM_2, and selects physical Display_N 124-4 for Guest_VM_N. The switching manager 318 then routes the display data 308 or the corresponding processed display data 312 of each guest VM 202 to their selected physical display(s) 124.

In some instances, two or more guest VMs 202 are assigned to the same physical display 124. For example, in FIG. 4, Guest_VM_2 202-3 and Guest_VM_N 202-4 are both assigned to physical Display_N 124-4. Therefore, in at least some implementations, the host domain compositor 132 implements one or more switching policies 320 to determine how and when to switch a physical display 124 between guest VM 202. As described above with respect to FIG. 3, the switching policies 320 indicate one or more of a set of rules, conditions, or parameters governing how the switching manager 318 switches the physical displays 124 between the guest VMs 202. In one example, a switching policy 320 configures the switching manager 318 to select which display data 308 received from multiple guest VMs 202 assigned to the same physical device 124 based on priority. Priority, in at least some implementations, is determined by the switching manager 318 based on features or attributes of the rendered data 308, the guest VM 202 associated with the rendered data, a combination thereof, or the like. Examples of these features or attributes include, display data 308 time of arrival, display data 308 data type, criticality or importance of the display data, criticality or importance of the guest VMs 202, a priority weight assigned to the guest VMs 202, a combination thereof, or the like.

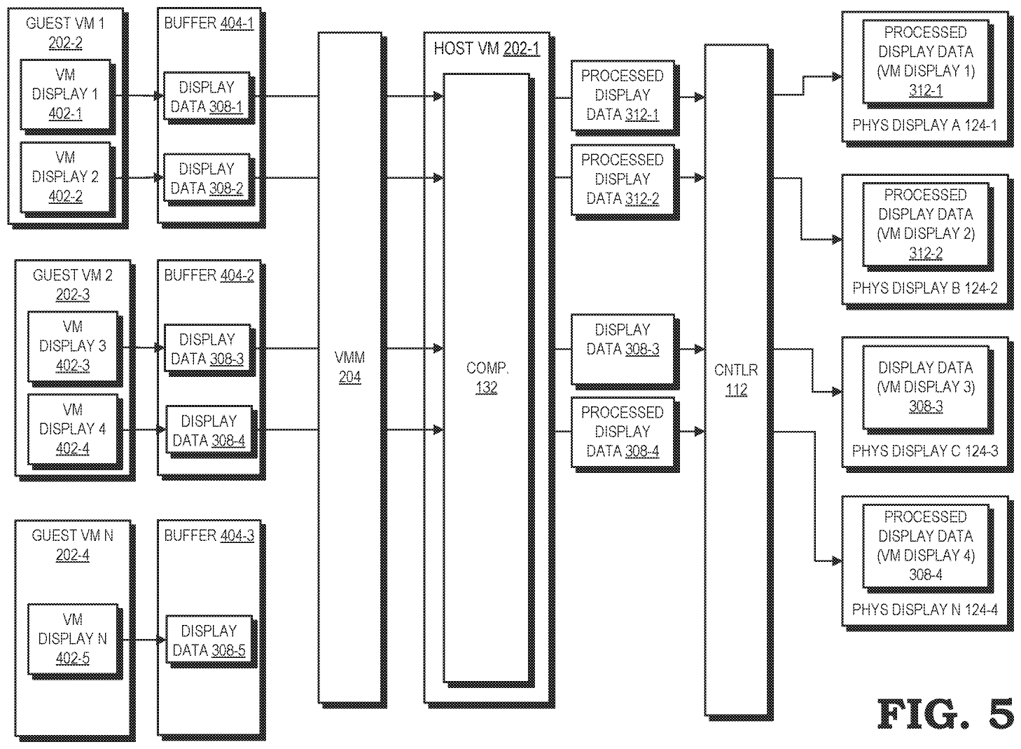

In the example shown in FIG. 4, the switching manager 318 selects physical Display_N 124-4 for Guest_VM_N 202-4 over Guest_VM_2 202-3, as indicated by the dashed line 406. Therefore, in this example, the display data 308-5 received from guest VM_N 202-4 is processed and output for display by physical Display_N 124-4, whereas the display data 308-4 received from guest VM_2 202-3 is maintained by the host domain compositor 132 for output to the physical Display_N 124-4 at a later time, as shown in FIG. 5. For example, in FIG. 5, after a threshold period of time has passed since the display data 308-5 received from guest VM_N 202-4 was output to the physical Display_N 124-4, the host domain compositor 132 routes the display data 308-4 received from guest VM_2 202-3 to physical Display_N 124-4. In at least some implementations, the threshold period of time is indicated by the switching policy 320. In another example, after the physical Display_N 124-4 has completed presenting the display data 308-5 received from guest VM_N 202-4, the host domain compositor 132 routes the display data 308-4 received from guest VM_2 202-3 to physical Display_N 124-4.

Also, in some instances, the host domain compositor 132 receives display data 308 from one (or more) of the guest VMs 202 assigned to a physical device 124 currently presenting display data 308 from another guest VM 202. In at least some implementations, if the received display data 308 is of higher priority than the display data 308 currently being presented by the physical display 124 or satisfies another condition of a switching policy 320, the host domain compositor 132 outputs the received display data 308 to the physical display 124. This triggers the physical display 124 to stop outputting the current display data 308 and to output the higher priority display data 308.

In at least some implementations, the host domain compositor 132 outputs display data 308 (or processed display data 312) to a physical device 124 via the display controller 112. For example, host domain compositor 132 outputs display data 308 (or processed display data 312) to one or more frame buffers (not shown) of the display controller 112. The display controller 112 takes display data 308 (or processed display data 312) from the frame buffer(s) and converts the display data 308 (or processed display data 312) into one or more signals. The display data 308 (or processed display data 312) includes, for example, pixel data such as pixel values for the image or frame to be displayed, frame information (e.g., frame resolution, color depth, color format, etc.), metadata (e.g., color calibration data, high dynamic range (HDR) information, etc.). The signal(s) includes information regarding colors, brightness, pixel position, and anything else needed to create the image on the physical display(s) 124. The display controller 112 outputs the signal(s) to physical display(s) 124 through one or more display interfaces. The physical display(s) 124 the outputs the display data 308 (or processed display data 312) represented by the received signals.

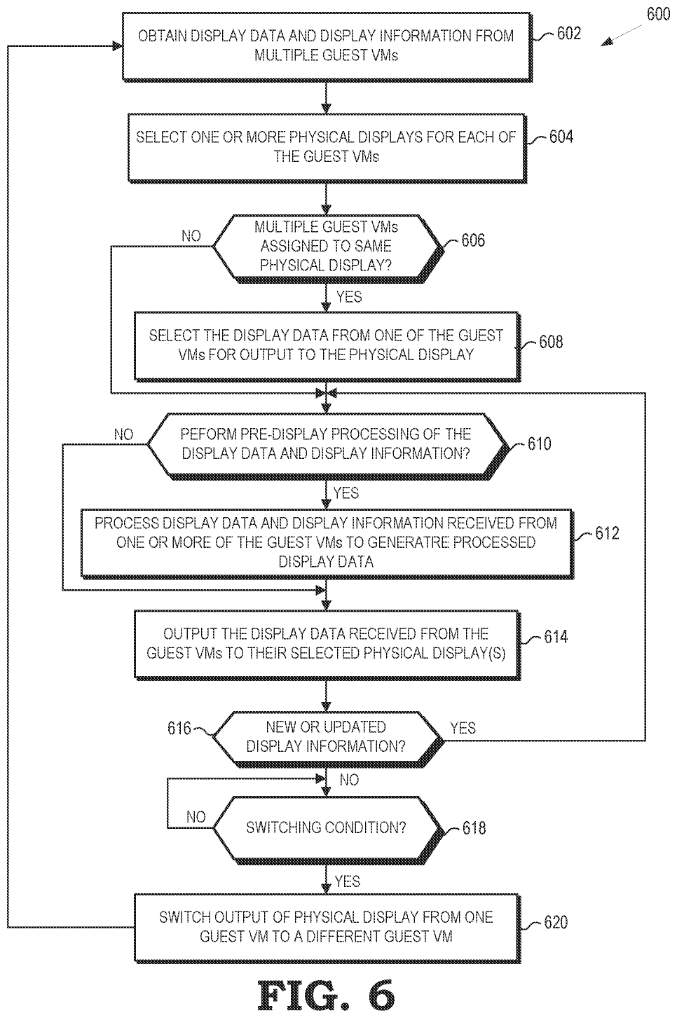

FIG. 6 is a diagram illustrating an example method 600 of the host domain compositor 132 managing display data 308 generated by multiple guest VMs 202 in accordance with at least some implementations. It should be understood that the processes described below with respect to method 600 have been described above in greater detail with reference to FIG. 1 to FIG. 5. For purposes of description, the method 600 is described with respect to an example implementation at the computing system 100 of FIG. 1 or FIG. 2, but it will be appreciated that, in other implementations, the method 600 is implemented at processing devices having different configurations. Also, the method 600 is not limited to the sequence of operations shown in FIG. 6, as at least some of the operations can be performed in parallel or in a different sequence. Moreover, in at least some implementations, the method 600 can include one or more different operations than those shown in FIG. 6.

The method 600 begins after the virtualization environment 130 has been instantiated with a host VM 202-1, a plurality of guest VMs 202, and the host domain compositor 132 within the host VM 202-1. At block 602, the host domain compositor 132 obtains display data 308 from each of a plurality of guest VMs 202. In at least some implementations, the host domain compositor 132 also receives display information/properties 306 from at least one of the plurality of guest VMs 202. At block 606, the host domain compositor 132 selects one or more physical displays 124 for each of the guest VMs 202. For example, the host domain compositor 132 uses the VM mapping information 310 or the display switching information 314 to determine which physical display 124 to select for a guest VM 202. At block 606, the host domain compositor 132 determines if two or more of the guest VMs 202 are assigned or mapped to the same physical display 124. If two or more of the guest VMs 202 are not assigned or mapped to the same physical display 124, the method proceeds to block 610. Otherwise, at block 608, the host domain compositor 132 selects the display data 308 of one of the guest VMs 202 for output to the physical display 124 and maintains the display data 308 of the remaining guest VMs 202 assigned to the physical display 124 for output at a later time. As described above, in at least some implementations, the host domain compositor 132 implements one or more switching policies 320 to determine which display data 308 to select over other display data 308 for output to a given physical display 124.

At block 610, the host domain compositor 132 determines if pre-display processing of each set of display data 308 received from the guest VMs 202 is to be performed. For example, based on the display information 306 for each selected physical display 124, the host domain compositor 132 determines if the format or resolution of the display data 308 to be output by a selected physical display 124 is to be changed. If the host domain compositor 132 determines that none of the display data 308 is to be processed, the method 600 proceeds to block 614. Otherwise, at block 612, the host domain compositor 132 processes the display data 308 received from one or more of the guest VMs 202 to generate processed display data 312. In at least some implementations, the host domain compositor 132 also processes the display information 306 to configure the target physical display(s) 124 based on the display information 306. At block 614, the host domain compositor 132 outputs the display data 308 (or processed display data 312) of the guest VMs 202 to their select physical display(s) 124.

At block 616, the host domain compositor 132 determines if new or updated display information 306 has been received from one of more of the guest VMs 202. In at least some implementations, this determination is repeatedly performed. If new or updated display information 306 has been received, the method 600 returns to block 610 (or another block). At block 618, if new or updated display information 306 has not been received, the host domain compositor 132 determines if any switching condition has occurred. For example, the host domain compositor 132 determines if any display data 308 (or processed display data 312) is queued for a physical display 124 currently selected for another guest VM 202 and a threshold period of time has passed or the physical display 124 has finished outputting the prior display data 308. If the host domain compositor 132 determines that a switching condition has not occurred, the host domain compositor 132 continues to monitor for a switching condition. Alternatively, the method 600 returns to block 602. At block 620, if a switching condition has occurred, the host domain compositor 132 switches the output of the physical display 124 from its current guest VM 202 to a different guest VM 202. The method 600 then returns to, for example, block 602.

One or more of the elements described above is circuitry designed and configured to perform the corresponding operations described above. Such circuitry, in at least some implementations, is any one of, or a combination of, a hardcoded circuit (e.g., a corresponding portion of an application-specific integrated circuit (ASIC) or a set of logic gates, storage elements, and other components selected and arranged to execute the ascribed operations), a programmable circuit (e.g., a corresponding portion of a field programmable gate array (FPGA) or programmable logic device (PLD)), or one or more processors executing software instructions that cause the one or more processors to implement the ascribed actions. In some implementations, the circuitry for a particular element is selected, arranged, and configured by one or more computer-implemented design tools. For example, in some implementations the sequence of operations for a particular element is defined in a specified computer language, such as a register transfer language, and a computer-implemented design tool selects, configures, and arranges the circuitry based on the defined sequence of operations.

Within this disclosure, in some cases, different entities (which are variously referred to as “components”, “units”, “devices”, “circuitry”, etc.) are described or claimed as “configured” to perform one or more tasks or operations. This formulation of [entity] configured to [perform one or more tasks] is used herein to refer to structure (i.e., something physical, such as electronic circuitry). More specifically, this formulation is used to indicate that this physical structure is arranged to perform the one or more tasks during operation. A structure can be said to be “configured to” perform some task even if the structure is not currently being operated. A “memory device configured to store data” is intended to cover, for example, an integrated circuit that has circuitry that stores data during operation, even if the integrated circuit in question is not currently being used (e.g., a power supply is not connected to it). Thus, an entity described or recited as “configured to” perform some task refers to something physical, such as a device, circuitry, memory storing program instructions executable to implement the task, etc. This phrase is not used herein to refer to something intangible. Further, the term “configured to” is not intended to mean “configurable to”. An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

In some implementations, certain aspects of the techniques described above may implemented by one or more processors of a processing system executing software. The software includes one or more sets of executable instructions stored or otherwise tangibly embodied on a non-transitory computer-readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific implementations. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific implementations. However, the benefits, advantages, solutions to problems, and any feature(s) that may cause any benefit, advantage, or solution to occur or become more pronounced are not to be construed as a critical, required, or essential feature of any or all the claims. Moreover, the particular implementations disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular implementations disclosed above may be altered or modified and all such variations are considered within the scope of the disclosed subject matter. Accordingly, the protection sought herein is as set forth in the claims below.

What is claimed is:

1. A method comprising:
receiving, by a compositor within a host domain of a virtualization environment, a first set of display data from a first guest virtual machine and a second set of display data from a second guest virtual machine; and
outputting, by the compositor, the first set of display data to a first physical display, and the second set of display data to a second physical display.

2. The method of claim 1, wherein outputting the first set of display data and the second set of display data comprises:
responsive to determining that the first physical display is assigned to the first guest virtual machine, selecting the first physical display to receive the first set of display data; and
responsive to determining that the second physical display is assigned to the second guest virtual machine, selecting the second physical display to receive the second set of display data.

3. The method of claim 1, further comprising:
receiving a third set of display data from a third guest virtual machine; and
responsive to determining that the first guest virtual machine and the third guest virtual machine are assigned to the first physical display, selecting the first set of display data over the third set of display data for outputting to the first physical display.

4. The method of claim 3, further comprising:
responsive to determining that one or more switching conditions have occurred, outputting the third set of display data to the first physical display.

5. The method of claim 4, wherein the one or more switching conditions include at least one of a determining that the first physical display has completed outputting the first set of display data, a threshold period of time having passed since the first set of display data was output to the first physical display, or a determination that the third set of display data has a higher priority than the first set of display data.

6. The method of claim 1, further comprising:
pre-processing at least the first set of display data prior to outputting the first set of display data to the first physical display.

7. The method of claim 6, wherein pre-processing the first set of display data comprises at least one of:
transforming the first set of display data into a format compatible with the first physical display; or
applying one or more display features to the first set of display data.

8. A computing system, comprising:
memory;
at least one processor; and
a compositor implemented within a host virtual machine, the compositor to:
receive a first set of display data from a first guest virtual machine of a plurality of guest virtual machines and a second set of display data from a second guest virtual machine of the plurality of guest virtual machines; and
output the first set of display data to a first physical display, and the second set of display data to a second physical display.

9. The computing system of claim 8, wherein the compositor is to output the first set of display data and the second set of display data by:
selecting the first physical display to receive the first set of display data in response to a determination that the first physical display is assigned to the first guest virtual machine; and
selecting the second physical display to receive the second set of display data in response to a determination that the second physical display is assigned to the second guest virtual machine.

10. The computing system of claim 8, wherein the compositor is further to:
receive a third set of display data from a third guest virtual machine of the plurality of guest virtual machines; and
select the first set of display data over the third set of display data for outputting to the first physical display in response to a determination that the first guest virtual machine and the third guest virtual machine are assigned to the first physical display.

11. The computing system of claim 10, wherein the compositor is further to:
output the third set of display data to the first physical display in responsive to determining that one or more switching conditions have occurred.

12. The computing system of claim 11, wherein the one or more switching conditions include at least one of a determining that the first physical display has completed outputting the first set of display data, a threshold period of time having passed since the first set of display data was output to the first physical display, or a determination that the third set of display data has a higher priority than the first set of display data.

13. The computing system of claim 8, wherein the compositor is further to:
pre-process at least the first set of display data prior to outputting the first set of display data to the first physical display.

14. The computing system of claim 13, wherein the compositor is to pre-process the first set of display data by at least one of:
transforming the first set of display data into a format compatible with the first physical display; or
applying one or more display features to the first set of display data.

15. A method comprising:
executing a virtualization environment at a computing system;
instantiating a host virtual machine within the virtualization environment;
instantiating a plurality of guest virtual machines within the virtualization environment; and
executing a compositor within the host virtual machine, the compositor configured to output display data received from each guest virtual machine of the plurality of guest virtual machines to different physical displays.

16. The method of claim 15, further comprising:
responsive to determining that a first guest virtual machine of the plurality of guest virtual machines and a second guest virtual machine of the plurality of guest virtual machines are assigned to the same physical display, selecting, by the compositor, a first set of display data received from the first guest virtual machine over a second set of display data received from the second guest virtual machine for outputting to the physical display.

17. The method of claim 16, further comprising:
responsive to determining that one or more switching conditions have occurred, outputting, by the compositor, the second set of display data to the physical display.

18. The method of claim 17, wherein the one or more switching conditions include at least one of a determining that the physical display has completed outputting the first set of display data, a threshold period of time having passed since the first set of display data was output to the physical display, or a determination that the second set of display data has a higher priority than the first set of display data.

19. The method of claim 15, further comprising:
pre-processing, by the compositor, a set of display data received from at least one guest virtual machine of the plurality of guest virtual machines prior to outputting the set of display data to a physical display assigned to the at least one guest virtual machine.

20. The method of claim 19, wherein pre-processing the set of display data comprises at least one of:
transforming the set of display data into a format compatible with the physical display assigned to the at least one guest virtual machine; or
applying one or more display features to the set of display data.
